(19) United States
(12) Patent Application Publication
(10) Pub. No.: US 2026/0159081 A1
(43) Pub. Date: Jun. 11, 2026

(54) METHOD FOR MAINTAINING A VEHICLE IN THE CENTRE OF ITS TRAFFIC LANE

(71) Applicant: AMPERE S.A.S., Boulogne Billancourt (FR)

(72) Inventors: Luc BROSSARD, Guyancourt cedex (FR); Pedro KVIESKA, Guyancourt cedex (FR)

(73) Assignee: AMPERE S.A.S., Boulogne Billancourt (FR)

(21) Appl. No.: 19/129,188

(22) PCT Filed: Nov. 7, 2023
(86) PCT No.: PCT/EP2023/081046

§ 371 Date: May 12, 2025

(30) Foreign Application Priority Data
Nov. 14, 2022 (FR) FR2211836

(51) Int. Cl. B60W 30/12; B60W 10/20; G06V 10/44; G06V 20/56

(52) U.S. Cl. CPC B60W 30/12; B60W 10/20; G06V 10/44; G06V 20/588; B60W 2420/403; B60W 2520/10; B60W 2552/35; B60W 2552/53; B60W 2555/60

(57) ABSTRACT

A method is for steering a motor vehicle driving on a road having at least one traffic lane. The method includes detecting the edges of the traffic lane of the motor vehicle, selecting, by a computer of the motor vehicle, an activated or deactivated state of a function for automatically keeping the motor vehicle in the traffic lane, and when the activated state is selected, controlling at least one steering actuator of the motor vehicle in order to keep it in the traffic lane. As part of the detecting, a width of the traffic lane is evaluated. As part of the selecting, the state of the function for automatically keeping the motor vehicle in the traffic lane is selected depending on the evaluated width.

### TECHNICAL FIELD OF THE INVENTION

The present invention relates generally to driving assistance systems of motor vehicles.

The invention relates more precisely to a method for steering a motor vehicle travelling on a road that comprises at least one traffic lane, comprising steps of:
detecting the edges of the traffic lane used by the motor vehicle,
selecting, by way of a computer of the motor vehicle, an activated or deactivated state of a function for automatically keeping the motor vehicle in said traffic lane, and then
when the activated state is selected, controlling at least one steering actuator of the motor vehicle in order to keep the vehicle in said traffic lane.

It also relates to a motor vehicle suitable for carrying out such a method. It applies more particularly to cars and other motorized vehicles travelling on roads.

### PRIOR ART

In the interest of increasing the safety of motor vehicles, they are currently being equipped with driving assistance systems or even systems for highly automated driving.

These are typically systems for keeping a vehicle in its lane, namely systems for keeping a vehicle within its lane or for keeping a vehicle in the center of its lane (more commonly known by the acronyms LKA, for Lane Keeping Assist, and LCA, for Lane Centering Assist).

To operate, such a system needs to know the position of the edges of the traffic lane used by the vehicle. At present, it is known practice to accomplish this by using a sensor, such as a camera, that incorporates image processing means in order to determine the position of these lane edges.

It can be seen that detection of the edges of the traffic lane needs to be extremely reliable in order to prevent the vehicle from leaving said lane.

Unfortunately, such detection is not always entirely satisfactory.

Indeed, the applicant has been able to determine that, on some narrow two-way secondary roads (“country roads”), the two lines marking the edges of the roadway are classed as forming the edges of the traffic lane. It can be seen that, in this situation, the vehicle is then steered to center itself not in relation to its traffic lane but rather in relation to the road, to such an extent that it straddles two lanes, which is undesirable (since the driver, with their hands on the steering wheel, then has to correct the trajectory of the vehicle).

### OUTLINE OF THE INVENTION

To overcome the aforementioned disadvantage of the prior art, the present invention proposes relying on at least one parameter (the width of the detected traffic lane) to check that the data on which the function for automatically keeping the vehicle in the center of its traffic lane relies are reliable.

More particularly, the invention proposes a steering method as defined in the introduction, wherein:
in the detection step, a width of said traffic lane is evaluated, and
in the selection step, the state of the function for automatically keeping the motor vehicle in the traffic lane is selected according to the evaluated width.

Thus, courtesy of the invention, if the width of the traffic lane has a value that is surprising in itself or surprising in consideration of other parameters collected by the vehicle, it is possible to deactivate the function for automatically keeping the vehicle in the center of its traffic lane in order to prevent the driver from having to correct the trajectory of the vehicle that is imposed by actuators.

Other advantageous and nonlimiting features of the steering method according to the invention, taken individually or according to all combinations that are technically possible, are as follows:
there is provision for a step of measuring a surface quality of the road;
in the selection step, the state of the function for automatically keeping the motor vehicle in the traffic lane is selected according to the measured quality;
there is provision for a step of acquiring a maximum permitted speed on said road;
in the selection step, the state of the function for automatically keeping the motor vehicle in the traffic lane is determined according to said acquired maximum permitted speed;
there is provision for a step of acquiring a speed-of-travel regulation setpoint of the motor vehicle;
in the selection step, the state of the function for automatically keeping the motor vehicle in the traffic lane is selected according to said speed-of-travel regulation setpoint;
if the evaluated width is below a minimum threshold, the activated state is suitable for selection;
if the evaluated width is above a maximum threshold, the deactivated state is selected;
if the evaluated width is between the minimum threshold and the maximum threshold, the state of the function for automatically keeping the motor vehicle in the traffic lane is selected differently depending on whether the evaluated width is between two intermediate thresholds that are between the minimum threshold and the maximum threshold, or whether the evaluated width is below the lowest of the two intermediate thresholds, or whether the evaluated width is above the highest of the two intermediate thresholds;
when the evaluated width is between the two intermediate thresholds: if the maximum permitted speed is above a speed threshold, the activated state is suitable for selection, but if the maximum permitted speed is below the speed threshold, the state of the function for automatically keeping the motor vehicle in the traffic lane is selected according to the measured quality;
when the evaluated width is between the minimum threshold and the lowest of the two intermediate thresholds: if the measured quality is above a quality threshold, the activated state is suitable for selection, but if the measured quality is below the quality threshold, the deactivated state is selected;
if the evaluated width is between the highest of the two intermediate thresholds and the maximum threshold, the state of the function for automatically keeping the motor vehicle in the traffic lane is selected according to the measured quality and the maximum permitted speed.

The invention also relates to a motor vehicle comprising means for detecting the edges of a traffic lane of a road that it is using, at least one steering actuator of the motor vehicle, and a computer programmed to carry out a steering method as mentioned above.

Of course, the different features, variants and embodiments of the invention can be associated with one another in different combinations unless they are incompatible or mutually exclusive.

### DETAILED DESCRIPTION OF THE INVENTION

The description that follows with reference to the appended drawings, which are provided as nonlimiting examples, will clearly explain the essence of the invention and how the invention can be implemented.

In the appended drawings:

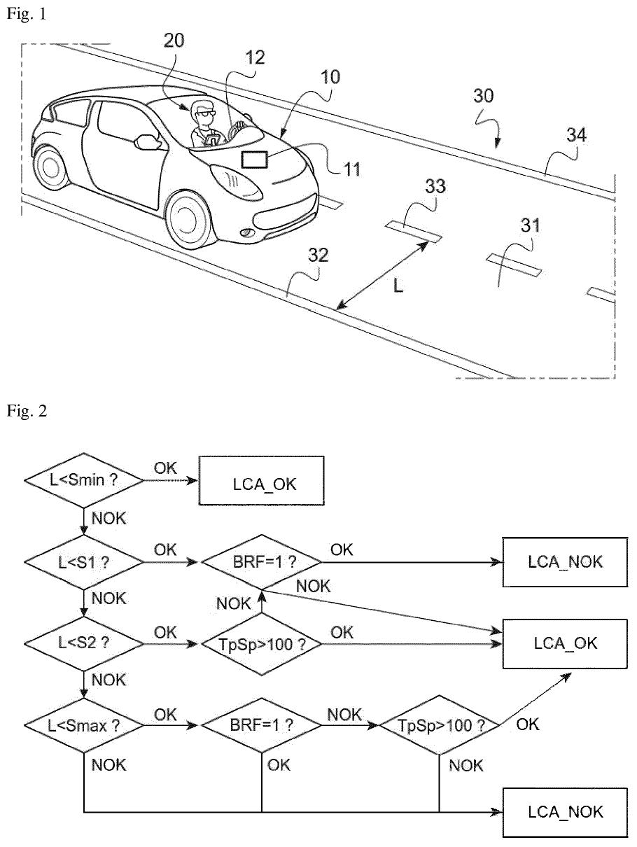

FIG. 1 is a schematic view of a motor vehicle suitable for carrying out a method according to the present invention;

FIG. 2 is a block diagram illustrating various steps of a method according to the present invention.

FIG. 1 shows a motor vehicle 10 suitable for carrying out the invention.

Here, it is a car. Alternatively, it could be another type of vehicle (truck, motorcycle, etc.).

Here, this vehicle 10 conventionally comprises a passenger compartment that contains in particular a seat for the driver 20 of the vehicle and a steering wheel 12.

This vehicle 10 comprises a powertrain, a braking system and a steering system that can be used to turn the vehicle (these not being visible in the figure). Conventionally, the steering system comprises an electronically controllable assisted steering actuator, the powertrain comprises an electronically controllable engine control actuator, and the braking system comprises an electronically controllable braking actuator.

The vehicle 10 moreover comprises an electronic and/or computer processing unit (called a computer 11 below) comprising at least one microprocessor, at least one memory and input and output interfaces.

Courtesy of its input interfaces, the computer 11 is suitable for receiving various input data that come from Sensors or third-party computers.

Among these sensors, there is provision for example for a device such as a front camera and/or a radar remote sensor and/or a lidar remote sensor, which is used to locate the edges of the traffic lane used by the motor vehicle 10.

Courtesy of its output interfaces, the computer 11 is suitable for controlling the assisted steering actuator, the engine control actuator and the braking actuator.

Courtesy of its memory, the computer 11 stores a computer application consisting of computer programs comprising instructions whose execution by the computer allows a function for automatically keeping the vehicle in the center of its traffic lane (called the LCA function below), and the method described below, to be carried out.

FIG. 1 shows the motor vehicle 10 in perspective when it is travelling in a traffic lane 31 of a road 30.

A traffic lane is defined here as the part of a road on which a single vehicle alone is permitted to travel at once. Such a traffic lane is generally delimited between marking lines. In FIG. 1, there are two lateral marking lines 32, 34 delimiting the road, and one central marking line 33 delimiting the two traffic lanes.

A road (or roadway) is itself defined as a set of traffic lanes. In the example considered by way of illustration here, this road 30 therefore comprises two traffic lanes 31 in which the vehicles can travel in opposite directions.

The aim is to determine whether, taking account of data that the computer is able to collect, the LCA function can be activated or, conversely, whether it needs to be deactivated for safety reasons.

The method that follows is then carried out in a continuous loop, with a reduced time step (of the order of one tenth of a second, for example). It comprises three main steps.

During a first step, the computer acquires data including the position of the edges of the traffic lane 31 used by the motor vehicle 10 (simply called the “traffic lane 31” below).

In practice, the camera or the remote sensor used comprises a processor that is used to process the data that it receives and to provide the computer 11 with “line equations” illustrating the positions and shapes of the edges of the traffic lane 31, which are expressed in a frame of reference attached to the motor vehicle.

Of course, the computer could perform these data processing operations itself.

At this stage, the data received by the computer 11 could be regarded as being exact, and the two line equations received could be regarded as correctly illustrating the shapes and positions of the marking lines 32, 33 that border the traffic lane 31.

However, for example because the central marking line 33 is faded or not very visible, it may be that the computer receives, instead of these two equations, the equations of the lateral marking lines 32, 34 (those that border the road 30 rather than the traffic lane 31). It can be seen that, in this situation, the LCA function would take the vehicle to the center of the road 30, straddling the two traffic lanes, which would be potentially dangerous.

For that reason, the present invention proposes attempting to detect whether the vehicle 10 is in such a situation (referred to as an “undesirable situation”) so as then to block or interrupt the LCA function.

The idea for this is to rely on three parameters in order to detect whether the vehicle 10 is potentially in this undesirable situation.

Thus, in the first step, the computer acquires other data, namely:
the width L of the detected traffic lane 31 (it can be seen that in the event of a detection problem, the width will be that of the road 30),
the surface quality of the road 30, and
the maximum permitted speed in the traffic lane 31 or, if this datum is not available, the speed regulation setpoint of the vehicle.

This is because the quality of the surface of the road and the maximum permitted speed are data that, taken in combination with the width L of the detected traffic lane, can be used to distinguish a secondary road, on which there is a risk of poor detection of the edges of the traffic lane, from a highway (national road, freeway, etc.), where this risk is regarded as zero.

This is because a good surface condition of the surface and a high maximum permitted speed are generally representative of a highway (that is to say a road where the risk of the vehicle being in the undesirable situation identified above is zero).

In practice, the width L is evaluated on the basis of the line equations received. This width can be computed at the vehicle, in front of said vehicle, or by way of an average over a section of lane several meters in length.

The surface quality of the road 30 could be acquired in different ways. It could be read from a database, taking account of the geolocated position of the vehicle, but it will preferably be measured.

It could be measured according to the variations in travel of the vehicle's suspension. Here, it will be measured otherwise.

In a known manner, to determine the speed of the vehicle 10, the speed of rotation of each of its four wheels is measured. By applying a high-pass filter to the measurement signal of at least one of these speeds of rotation, it is possible to obtain high-frequency components related to the condition of the road.

Thus, when these components cross a predetermined threshold Sg, the quality of the surface of the road 30 can be regarded as being mediocre. In this case, the value “one” is assigned to a Boolean variable BRF that is representative of the quality of the surface and that is stored in the memory of the computer 11 (BRF=1).

Otherwise, the quality of the road is assessed as good, and so this variable remains equal to zero (BRF=0).

The maximum permitted speed on said road 30 can itself be obtained in various ways, for example by automatically reading signs lining the road, or in navigation software, taking account of the geolocated position of the vehicle.

When this datum is not known, it is possible to rely on another datum, namely the speed-of-travel regulation setpoint of the motor vehicle. This is because when the LCA function is activated, a function for automatically or adaptively regulating the speed of the vehicle is generally also activated, and so the setpoint is known.

Whatever the datum used (maximum permitted speed or speed setpoint), this datum will hereinafter be called the maximum speed TpSp.

Taking account of all of this information, the computer 11 determines, during a second step, whether the LCA function can be activated (or kept in the activated state if it was already activated) or whether it needs to be deactivated (or to remain inactive if it was already deactivated).

Whether the LCA function is activated or kept in the activated state will depend on the result of this second step, but it could also depend on other, third-party data (Is the vehicle in a built-up area? Is the weather fine? etc.).

Therefore, the computer determines the value of a status indicator during this second step.

This status indicator can take two values:
a value LCA OK, in which case the LCA function is regarded as being suitable for activation or for being kept in the activated state (its activation will also depend on the aforementioned third-party data), and
a value LCA NOK, in which case the LCA function is deactivated or kept in the deactivated state (whatever the aforementioned third-party data).

In this second step, the value of the status indicator is selected according to the evaluated width L. Depending on this width, it may also be selected according to the measured quality of the surface (i.e. the value of the variable BRF) and said maximum speed TpSp.

The method for selecting one or the other of the values LCA OK and LCA NOK of the status indicator is illustrated in FIG. 2.

This method comprises multiple successive substeps.

To begin with, the computer 11 determines whether the evaluated width L is below or equal to a minimum threshold Smin.

This minimum threshold Smin is less than 3 meters. Here, it is 2.8 m.

If the evaluated width L is below or equal to this minimum threshold Smin, the computer 11 deduces that the LCA function can be activated (the value LCA OK is selected).

This is because, in this situation, the detected traffic lane can be regarded as being SO narrow that it necessarily corresponds to a single traffic lane.

Otherwise, the computer determines whether the evaluated width L is below or equal to a first intermediate threshold S1.

This first intermediate threshold S1 is less than 3.5 meters. Here, it is 3.2 m.

If the evaluated width L is between the minimum threshold Smin and this first intermediate threshold S1, the computer determines the state of the LCA function solely according to the measured quality of the surface of the road 30.

This is because, in this situation, the detected traffic lane 31 is narrow and probably corresponds to one traffic lane of a secondary road, but it is deemed that there is, however, a minor risk of it being formed by two traffic lanes of a secondary road.

Here, to determine whether the vehicle is in an undesirable situation, the maximum speed TpSp is not considered, since, taking account of the width of the detected traffic lane, this speed is probably low, and so this parameter is not discriminatory.

In practice, if the surface is of poor quality (BRF=1), the value LCA NOK of the status indicator is selected in order to block the LCA function. Otherwise, the computer regards the LCA function as being able to be activated (the value LCA OK of the status indicator is selected).

If the evaluated width L is not between the minimum threshold Smin and the first intermediate threshold S1, the computer determines whether this width L is below a second intermediate threshold S2.

This second intermediate threshold S2 is preferably greater than 3.5 m but less than 4 m. Here, it is 3.8 m.

If the evaluated width L is between the two intermediate thresholds S1, S2, the computer selects the value of the status indicator at least according to the maximum speed TpSp.

This is because, taking account of the width L, it is likely that the vehicle is travelling on a highway, and an attempt is made to verify this.

In practice, if the maximum speed TpSp is above a speed threshold Sv (here, 100 km/h), the computer regards the LCA function as being able to be activated. This is because it is then deemed very likely that the road is a freeway.

Otherwise, since the type of road on which the vehicle 10 is travelling is not known, the computer 11 takes into account the quality of the surface of the road. Thus, if the surface is of poor quality (BR=1), the value LCA NOK of the status indicator is selected. This is because there is considered to be a risk that the vehicle is in the undesirable situation identified above. Conversely, if it is of good quality (BRF=0), the computer regards the LCA function as being able to be activated (the value LCA OK of the status indicator is selected).

If the evaluated width L is above the second intermediate threshold S2, the computer 11 checks whether this width L is below a maximum threshold Smax.

Here, this maximum threshold is 4 m.

If the evaluated width L is between the second intermediate threshold S2 and the maximum threshold Smax, it is likely that the vehicle is in a dangerous situation involving poor detection of the lane edge lines. This is because it is rare to find such wide traffic lanes.

In this situation, to permit the LCA function to be activated or kept in the activated state, the computer will check that the quality of the roadway is good and that the maximum speed TpSp is high. Otherwise, if at least one of these two conditions is not satisfied, it will be regarded as being likely that the vehicle is in an undesirable situation identified above.

In practice, the computer 11 first of all checks the quality of the roadway. If the roadway is not of good quality (BRF=1), the value LCA NOK of the status indicator is selected.

Otherwise, the computer checks whether the vehicle is on a fast road. If the maximum speed TpSp is below the speed threshold Sv, the value LCA NOK of the status indicator is selected.

Otherwise, the vehicle is regarded as being on a particularly wide highway, and the computer selects the value LCA OK to allow the LCA function to be activated.

Finally, if the computer determines that the evaluated width L is above the maximum threshold Smax, it is assumed that there is necessarily a detection error, since no traffic lane is more than 4 meters wide.

In that case, the value LCA NOK of the status indicator is selected.

Following this step and taking account of the acquired third-party data (weather, etc.), the state of the LKA function can be determined.

If the LCA function is deactivated, the driver needs to be responsible for controlling the steering of the vehicle, by using its steering wheel 12.

On the other hand, if the LCA function is activated, the computer 11 controls the steering actuator of the motor vehicle 10, during a third step, to keep the vehicle in the center of its traffic lane 31, taking account of the equations of the lane edge lines that are acquired (which are then regarded as reliable).

It will be noted in this respect that, within the scope of the driving aids envisaged in this presentation, the driver must already keep their hands on the steering wheel even when the LCA function is activated (the driver must maintain control of the vehicle, in particular with their eyes on the road and their hands on the steering wheel).

The present invention is by no means limited to the embodiment described and shown, but a person skilled in the art will be able to introduce any variant according to the invention thereto.

In particular, it will be possible to use multiple thresholds to assess the quality of the surface of the road 30. Thus, the quality of the surface will be able to be assessed as good (short of a first threshold), degraded (between two thresholds), or very degraded (beyond the second threshold).

In this variant, the method will then be carried out in the same way as mentioned above, but the threshold considered will depend on the speed of the vehicle. This is because at low speed (typically below 50 km/h), it is possible to detect that the vehicle is travelling in a built-up area, and it is then desired for the LCA function to be activated only if it is certain that the lane edge lines have been detected correctly. Taking account of the lowest threshold then allows greater demands to be made.

1-11. (canceled)

12. A method for steering a motor vehicle travelling on a road that comprises at least one traffic lane, the method comprising:
detecting edges of the traffic lane used by the motor vehicle;
selecting, by way of a computer of the motor vehicle, an activated or deactivated state of a function for automatically keeping the motor vehicle in said traffic lane, and
when the activated state is selected, controlling at least one steering actuator of the motor vehicle in order to keep said motor vehicle in the traffic lane,
wherein the detecting includes evaluating a width of said traffic lane, and
wherein the selecting includes selecting the state of the function for automatically keeping the motor vehicle in the traffic lane according to the evaluated width.

13. The steering method as claimed in claim 12, further comprising measuring a surface quality of the road,
wherein the selecting includes selecting the state of the function for automatically keeping the motor vehicle in the traffic lane according to the measured quality.

14. The steering method as claimed in claim 12, further comprising acquiring a maximum permitted speed on said road,
wherein the selecting includes determining the state of the function for automatically keeping the motor vehicle in the traffic lane according to said acquired maximum permitted speed.

15. The steering method as claimed in claim 12, further comprising acquiring a speed-of-travel regulation setpoint of the motor vehicle,
wherein the selecting includes selecting the state of the function for automatically keeping the motor vehicle in the traffic lane according to said speed-of-travel regulation setpoint.

16. The steering method as claimed in claim 12, wherein when the evaluated width is below a minimum threshold, the activated state is suitable for selection.

17. The steering method as claimed in claim 12, wherein when the evaluated width is above a maximum threshold, the deactivated state is selected.

18. The steering method as claimed in claim 12,
wherein when the evaluated width is below a minimum threshold, the activated state is suitable for selection,
wherein when the evaluated width is above a maximum threshold, the deactivated state is selected, and
wherein when the evaluated width is between the minimum threshold and the maximum threshold, the state of the function for automatically keeping the motor vehicle in the traffic lane is selected differently depending on whether:
the evaluated width is between two intermediate thresholds that are between the minimum threshold and the maximum threshold,
the evaluated width is below the lowest of the two intermediate thresholds, or
the evaluated width is above the highest of the two intermediate thresholds.

19. The steering method as claimed in claim 18, further comprising:
measuring a surface quality of the road, wherein the selecting includes selecting the state of the function for automatically keeping the motor vehicle in the traffic lane according to the measured quality; and
acquiring a maximum permitted speed on said road, wherein the selecting includes determining the state of the function for automatically keeping the motor vehicle in the traffic lane according to said acquired maximum permitted speed,
wherein when the evaluated width is between the two intermediate thresholds:
when the maximum permitted speed is above a speed threshold, the activated state is suitable for selection,
when the maximum permitted speed is below the speed threshold, the state of the function for automatically keeping the motor vehicle in the traffic lane is selected according to the measured quality.

20. The steering method as claimed in claim 19, wherein when the evaluated width is between the minimum threshold and the lowest of the two intermediate thresholds:
when the measured quality is above a quality threshold, the activated state is suitable for selection, and
when the measured quality is below the quality threshold, the deactivated state is selected.

21. The steering method as claimed in claim 19, wherein when the evaluated width is between the highest of the two intermediate thresholds and the maximum threshold, the state of the function for automatically keeping the motor vehicle in the traffic lane is selected according to the measured quality and the maximum permitted speed.

22. A motor vehicle comprising:
means for detecting the edges of the traffic lane of the road that the motor vehicle is using;
the at least one steering actuator of the motor vehicle; and
a non-transitory computer readable medium storing a program that, when executed by the computer, causes the computer to execute the steering method as claimed in claim 12.
